(19) United States
(12) Patent Application Publication
(10) Pub. No.: US 2011/0090130 A1
(43) Pub. Date: Apr. 21, 2011

(54) RFID READER ANTENNA AND RFID SHELF HAVING THE SAME

(75) Inventors: Won Kyu CHOI, Daejeon (KR); Jeong Seok KIM, Daejeon (KR); Ji Hoon BAE, Daejeon (KR); Gil Young CHOI, Daejeon (KR); Jong Suk CHAE, Daejeon (KR)

(73) Assignee: Electronics and Telecommunications Research Institute, Daejeon (KR)

(21) Appl. No.: 12/895,142

(22) Filed: Sep. 30, 2010

(30) Foreign Application Priority Data
Oct. 15, 2009 (KR) 10-2009-0098314
Feb. 5, 2010 (KR) 10-2010-0010967

(51) Int. Cl. H01Q 13/10

(52) U.S. Cl. 343/770

(57) ABSTRACT

An RFID reader antenna including: a printed circuit board (PCB) formed as a dielectric substance; a plurality of slot groups, each having a plurality of slots, disposed on a first face of the PCB; a ground face disposed on areas, excluding the plurality of slot groups, of the first face of the PCB; and a feeder formed as a microstrip line with an open end on a second face of the PCB to feed the plurality of slot groups. Because the slots periodically formed on the ground face are fed in series by using the single microstrip line, the RFID reader antenna can reliably recognize a larger area with a simple structure. In particular, the RFID reader antenna can be useful for the bookstands for book management or smart shelves for displaying articles or goods including clothing goods in superstores or hypermarkets through the use of the ILT RFID application.

### CROSS-REFERENCE TO RELATED APPLICATIONS

This application claims the priorities of Korean Patent Application Nos. 10-2009-0098314 filed on Oct. 15, 2009 and 10-2010-0010967 filed on Feb. 5, 2010, in the Korean Intellectual Property Office, the disclosures of which are incorporated herein by reference.

### BACKGROUND OF THE INVENTION

1. Field of the Invention

The present invention relates to an RFID reader antenna and an RFID shelf having the same, and more particularly, to an RFID reader antenna capable of simultaneously recognizing individual items located within a short distance thereof, and an RFID shelf having the same.

2. Description of the Related Art

Currently, the field of RFID applications is extending toward item level tagging (ILT) from the pallet, case or box-based tagging.

In general, a high frequency (HF) band RFID technique has been favored for ILT, which, however, is admitted to have problems with tag size and cost, recognition distance and data processing rate, compatibility with an existing UHF (Ultra-High Frequency) band RFID standard, and the like.

Unlike the HF band RFID technique employing magnetic coupling, the UHF band RFID technique using the back scattering of electromagnetic waves, having advantages in that it has a relatively long recognition distance such as 3 meters to 5 meters, has been extensively used for pallet-based distribution, box-based material management, and the like.

However, in the field of ILT applications, in which a great deal of items aggregate densely, the recognition rate in the performance of the UHF band RFID technique is drastically degraded due to the diffusion of electromagnetic waves and interference. Thus, in an effort to overcome the shortcomings of the UHF band RFID technique in the area of ILT, recently, an RFID technique using a near field in the UHF band or an RFID technique obtained by mixing the near field and a far field in the UHF band are being actively developed.

Developers of the UHF band RFID technique claim that the use of the far field of the UHF band for the pallet and box-based tagging and the use of the near field of the UHF band for a great deal of ILT would allow for the ILT as well as the tagging of pallets and boxes with a single frequency band.

Unlike the high frequency (HF) band RFID using magnetic coupling, the use of the near field of the UHF band allows for the suitable selection of magnetic coupling and electric coupling according to a tagged item and a service environment.

However, the UHF band near field RFID reader antenna must be designed with a different concept from that of the existing far field antenna. Namely, the UHF band near field RFID reader antenna must be designed in consideration of an ILT environment, a tagged position (namely, a tag-attached position of an item), a required near field distribution, and the like.

Also, near field communication is performed through coupling between the reader antenna and a tag antenna, the structure of the tag antenna must be taken into consideration in designing the reader antenna. In addition, in the case of recognizing a plurality of individual items which aggregate densely, the design concept of the reader antenna must vary depending on the distance between the reader antenna and an item to be recognized and the direction of the item.

Namely, when the plurality of items that aggregate densely are disposed within a relatively short distance of the reader antenna, the reader antenna needs to be designed to use the near field and the far field, while if a plurality of tag directions are not regular (or uniform), the reader antenna needs to be designed to have the characteristics of circular polarization.

### SUMMARY OF THE INVENTION

An aspect of the present invention provides a radio frequency identification (RFID) reader antenna capable of simultaneously recognizing individual items located within a short distance, and an RFID shelf having the same.

According to an aspect of the present invention, there is provided an RFID reader antenna including: a printed circuit board (PCB) formed as a dielectric substance; a plurality of slot groups, each having a plurality of slots, disposed on a first face of the PCB; a ground face disposed on areas, excluding the plurality of slot groups, of the first face of the PCB; and a feeder formed as a microstrip line with an open end on a second face of the PCB to feed the plurality of slot groups.

The plurality of slot groups may be disposed at a position in which a current distribution value by the feeder is greater than a predetermined current distribution value.

The plurality of slot groups may be disposed such that a phase difference between transmission signals by the slot groups is smaller than a predetermined phase difference.

The plurality of slot groups may be configured such that a strength value of the transmission signals by the slot groups is greater than a predetermined strength value.

The strength value of the transmission signals by the slot groups is controlled according to the length of a slot crossing the feeder.

The slot crossing the feeder is configured such that its length is greater as the slot is closer to the open end of the feeder.

The slot groups may be disposed such that transmission signals by the slot groups exhibit the characteristics of circular polarization.

The characteristics of the circular polarization of the transmission signals by the slot groups may be dependent upon the distance between the slots constituting the slot groups.

The slots constituting the slot groups may be disposed such that the transmission signals by the slots cross each other.

The slots constituting the slot groups may be disposed such that the phases of the transmission signals by the slots are different.

The phases of the transmission signals by the slots constituting the slot groups may be controlled according to the distance between the slots.

The feeder may be disposed such that standing waves are formed.

The feeder may be formed to provide serial feeding to the respective slot groups.

The feeder may have the form of meanders in order to compensate for its length.

The RFID reader antenna may use an ultra-high frequency (UHF) wavelength.

The RFID reader antenna may provide both a near field and a far field.

According to another aspect of the present invention, there is provided an RFID shelf including an RFID reader antenna including: a printed circuit board (PCB) formed as a dielectric substance; a plurality of slot groups, each having a plurality of slots, disposed on a first face of the PCB; a ground face disposed on areas, excluding the plurality of slot groups, of the first face of the PCB; and a feeder formed as a microstrip line with an open end on a second face of the PCB to feed the plurality of slot groups.

The slot groups may be disposed such that transmission signals by the slot groups exhibit the characteristics of circular polarization.

The characteristics of the circular polarization of the transmission signals by the slot groups may be dependent upon the distance between the slots constituting the slot groups.

The slots constituting the slot groups may be disposed such that the transmission signals by the slots cross each other.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a conceptual view for explaining an RFID reader antenna according to an exemplary embodiment of the present invention;

FIG. 2 is a view showing the configuration of the RFID reader antenna according to an exemplary embodiment of the present invention;

FIG. 3 is a conceptual view for explaining a current distribution by a feeder in the RFID reader antenna according to an exemplary embodiment of the present invention;

FIG. 4 is a sectional view of the RFID reader antenna according to an exemplary embodiment of the present invention;

FIG. 5 is a perspective view showing the configuration of slots of the RFID reader antenna according to an exemplary embodiment of the present invention;

FIG. 6 is a view for explaining the characteristics of circular polarization according to the configuration of the slots of the RFID reader antenna according to an exemplary embodiment of the present invention;

FIG. 7 is a perspective view showing the configuration of slots of the RFID reader antenna according to another exemplary embodiment of the present invention; and

FIG. 8 is a view for explaining the characteristics of circular polarization according to the configuration of the slots of the RFID reader antenna according to another exemplary embodiment of the present invention.

### DETAILED DESCRIPTION OF THE PREFERRED EMBODIMENT

The present invention may be embodied in many different forms and may have various embodiments, of which particular embodiments will be illustrated in drawings and will be described in detail.

However, it should be understood that the following exemplifying description of the invention is not meant to restrict the invention to specific forms of the present invention but rather the present invention is meant to cover all modifications, similarities and alternatives which are included in the spirit and scope of the present invention.

While such terms as “first” and “second,” etc., may be used to describe various components, such components must not be construed as being limited to the above terms. The above terms are used only to distinguish one component from another. For example, a first component may be referred to as a second component without departing from the scope of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist in-between. On the other hand, when a component is mentioned to be “directly connected” to or “directly accessing” another component, it is to be understood that there are no other components in-between.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have meanings equal to the contextual meanings in the relevant field of art, and are not to be interpreted to have ideal or excessively formal meanings unless clearly defined in the present application.

Embodiments of the present invention will be described below in detail with reference to the accompanying drawings, where those components are rendered the same reference number that are the same or are in correspondence, regardless of the figure number, and redundant explanations are omitted.

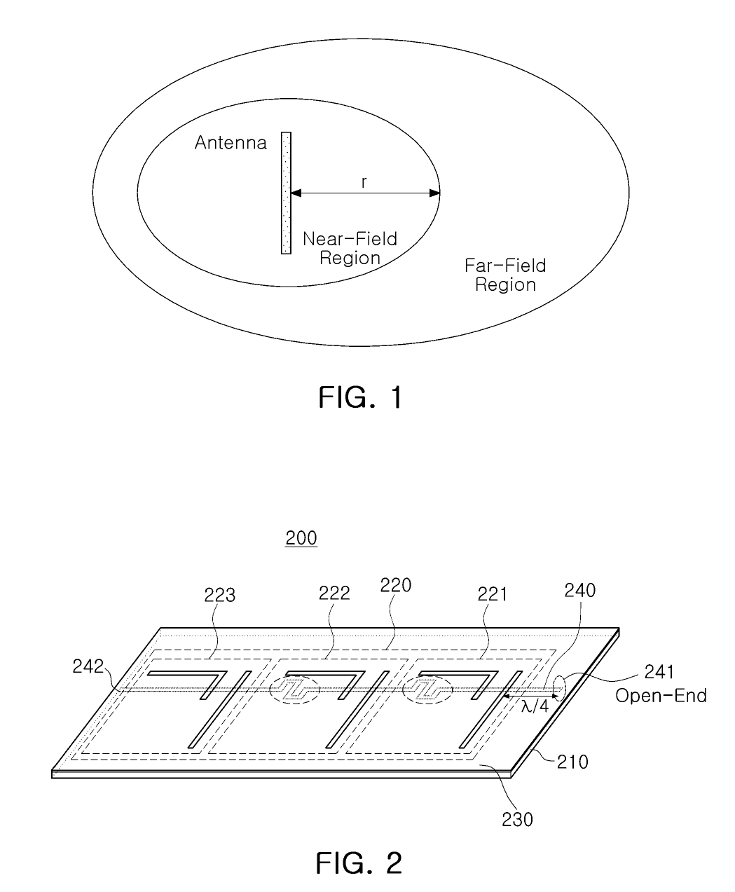

FIG. 1 is a conceptual view for explaining an RFID reader antenna according to an exemplary embodiment of the present invention.

With reference to FIG. 1, a near-field region and a far-field region of a general antenna are shown.

The near-field region refers to a region in which electric field energy or magnetic field energy is dense. In the near-field region, communications are performed between an RFID reader and a tag through electric coupling or magnetic coupling. The far-field region refers to a region in which electromagnetic waves existing as an electric field and a magnetic field are intensively coupled. In the far-field region, communications are performed between the RFID reader and the tag through the propagation of electromagnetic waves.

Thus, the design concept of the RFID tag and the reader antenna must be varied depending on where the RFID application is mainly made. In addition, the RFID application may include an RFID application in the far field, an RFID application in the near field, and an RFID application including the far field and the near field which are appropriately mixed.

In FIG. 1, ‘r’ is the distance roughly indicating the boundary between the near field region and the far field region based on the antenna. When based on the general antenna, r=2D²/λ, and when based on an electrically small antenna, r=μ/2π. In the above formula, ‘D’ is a maximum size, and λ is the wavelength of a central frequency.

FIG. 2 is a view showing the configuration of the RFID reader antenna according to an exemplary embodiment of the present invention.

With reference to FIG. 2, an RFID reader antenna 200 according to an exemplary embodiment of the present invention includes a printed circuit board (PCB) 210 formed as a dielectric substance, a plurality of slot groups 220, each having a plurality of slots, disposed on a first face of the PCB 210, a ground face 230 disposed on areas, excluding the plurality of slot groups, of the first face of the PCB, and a feeder 240 formed as a microstrip line with an open end on a second face of the PCB to feed the plurality of slot groups.

First, the PCB 210 refers to a thin plate on which chips and other electronic components are installed. In general, the PCB 210 is made of tempered fibrous glass or plastic, and the components installed on the PCB 210 are connected through circuits made of copper. Here, the PCB 210 may be formed as a dielectric substance.

Next, the plurality of slot groups 220 include a plurality of slots, respectively, and may be installed on the first face of the PCB 210. Namely, a plurality of slots constitute a single slot group, and the plurality of slot groups may be formed on the first face.

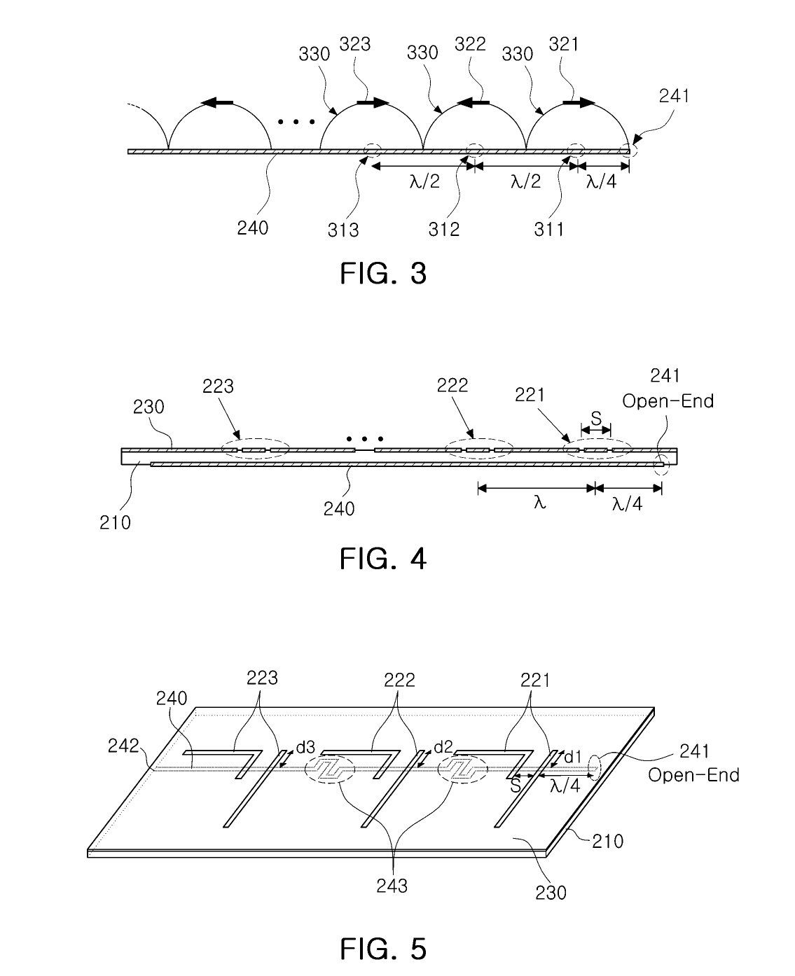

FIG. 3 is a conceptual view for explaining a current distribution by a feeder in the RFID reader antenna according to an exemplary embodiment of the present invention.

With reference to FIGS. 1 and 3, the plurality of slot groups 220 may be disposed such that their current distribution value by the feeder 240 is greater than a predetermined current distribution value. For example, the predetermined current distribution value may be a value smaller by 5 percent than a maximum current distribution value or may be a value smaller by 10 percent than the maximum current distribution value.

Also, the plurality of slot groups 220 may be disposed such that a phase difference between transmission signals of the slot groups is smaller than a predetermined phase difference. For example, the predetermined phase difference may be five degrees or ten degrees based on a transmission signal of a first slot group.

With reference to FIGS. 1 and 3, the feeder 240 has an open end 241, so when power is fed by using the feeder 240, a progressive wave and a reflective wave gather to form standing waves 330 on the feeder 240. The standing wave distribution 330 in FIG. 3 indicates a current distribution.

There is little current distribution at the open end 241, and the current distribution is maximized at a point 311 shifted by λ/4 from the open end 241. Each time the current distribution is shifted by λ/2 from the point 311 having the maximized current distribution, points 312 and 313, at which the current distribution is maximized, exist periodically.

However, there is a 180 degree difference between a current phase 321 at the point 311 having the maximized current distribution and a current phase 322 at the point 312, having the maximized current distribution, shifted by λ/2 from the point 311. A current phase 323 at the point 313, having the maximized current distribution, shifted by λ/2 from the point 312 is different by 180 degrees from the current phase 322 at the point 312 having the maximized current distribution.

Namely, it is to be noted that the current distribution is maximized at the point 313 shifted by the multiple of λ distance from the point 311 which is closest to the end point 241 of the feeder 240 and has the maximized current distribution, and the points 311 and 313 having the same phases 321 and 323 are formed periodically.

Thus, a slot which is to be resonated at a pertinent frequency and has an appropriate shape may be formed at a position corresponding to the point having the maximized current distribution and shifted by the multiple of λ distance from the point 311 being closest to the end point 241 of the feeder 240 and having the maximized current distribution, in order to effectively radiate a transmission signal through the slot.

Namely, in order to feed current having uniform size and phase to the plurality of slots, in an exemplary embodiment of the present invention, slot groups are formed periodically at a point distant by λ/4 from the end of the feeder 240 and at a point distant by λ interval from the λ/4 point, and the feeder 240 is designed such that the slot groups are excited with the current distribution having the uniform phase and size. Then, a substantially uniform near field can be generated in an extensive range by using the single feeder 240 and the periodically formed slot groups.

The plurality of slot groups 220 may be disposed such that their transmission signals have the characteristics of circular polarization, and the characteristics of circular polarization of the transmission signals of the slot groups 220 may be created depending on the distance between slots constituting the slot groups.

The slots constituting the slot group 220 may be disposed such that the transmission signals by the slots cross each other. Also, the slots constituting the slot group 220 may be disposed such that the phases of the transmission signals by the slots are different. Also, the phases of the transmission signals by the slots constituting the slot group 220 may be controlled according to the distance between the slots.

FIG. 4 is a sectional view of the RFID reader antenna according to an exemplary embodiment of the present invention.

With reference to FIGS. 1 and 4, the ground face 230 is formed on the first face (i.e., an upper face) of the PCB 210, and the feeder 240 is formed on the second face (i.e., a lower face) of the PCB 210. The slots 221, 222, and 223 resonated at a particular frequency for radiating electromagnetic waves are periodically formed on the ground face 230.

Current distributions having the form of standing waves are formed at the feeder 240 with the open end 241. The point having the maximized current distribution exists at a position distant by λ/4 from the end point 241 of the feeder 240, and one slot group 221 that resonates at a particular frequency is formed at the point of the ground face 230.

The slot group 221 formed on the ground face 230 may have various shapes according to applications of the present invention. Namely, the slot group may include a pair of slots or may include three or more slots. In addition, each slot may have various shapes. Hereinafter, it is assumed that one slot group includes two slots.

Also, in order to allow the antenna to radiate an electric field having the characteristics of circular polarization, the slots of the slot group 221 are formed to cross each other and currents exciting each slot may have a phase difference of 90 degrees. Here, the phase difference between the currents exciting the two slots may be controlled by the distance ‘S’.

Namely, the two slots may be formed such that the currents exciting the two slots, perpendicular to each other, have the phase difference of 90 degrees by using the distance between the two slots. Also, in the case of three or more slots, the slots may be configured to emit an electric field having the characteristics of circular polarization by using the same method as described above.

With reference to FIGS. 1 and 4, a point being shifted by the distance of λ from the point where the slot group 221 exists has the same sizes of current distribution and phase as those of the point where the slot group 221 exists. In other words, the point (or the corresponding area) away by the distance of λ from the slot group 221 has the same sizes of current distribution and phase as those of the slot group 221, and the slot group 222 having the same form as that of the slot group 221 is formed at the point, and the plurality of slot groups 221, 222, and 223 may be fed with the current having the same current distribution and phase.

Namely, the current distribution having the same phase and size may be formed at the plurality of slots 221, 222, and 223 periodically formed at the intervals of λ by using the feeder 240 where the current distribution in the form of the standing waves exist.

The ground face 230 may be the areas, other than the plurality of slot groups, of the first face of the PCB 210. Namely, because the plurality of slot groups 220 existing on the first face of the PCB 210 are used to radiate electromagnetic waves, the areas other than the plurality of slots groups are all formed as the ground face.

The feeder 240 may be disposed to form standing waves. The feeder 240 may be formed to perform serial feeding on the respective slot groups. Also, the feeder 240 may have the form of meanders in order to compensate for its length.

FIG. 5 is a perspective view showing the configuration of slots of the RFID reader antenna according to an exemplary embodiment of the present invention.

With reference to FIG. 5, the RFID reader antenna according to an exemplary embodiment of the present invention has a structure in which the slot groups 220 periodically formed on the ground face 230 of the PCB 210 are fed in series by using the feeder 240 formed on the opposite side of the PCB 210.

Namely, the RFID reader antenna according to an exemplary embodiment of the present invention includes the PCB 210 configured as a single dielectric layer, the feeder 240 formed at a lower end of the PCB 210 and feeding power, and the ground face 230 formed at an upper end of the PCB 210. A plurality of slot groups 221, 222, and 223 for radiating electromagnetic waves may exist on the ground face 230.

When the plurality of slot groups 221, 222, and 223 are fed in series by using the feeder 240 formed as a microstrip line, the amount of current is gradually reduced toward the end 241 from a feeding point 242, so the amount of current exciting the slot group of the final stage may be very small.

Namely, the current, starting to feed from the feeding point 242, excites the first slot group 223, the second slot group 222, and then the last slot group 221, and while performing this process, the exciting current is gradually reduced while passing through the slot groups 223, 222, and 221.

Thus, in the exemplary embodiment of the present invention, in order to solve this problem, the distances d3, d2, and d1 at which the feeder 240 and the slots cross each other are used. Namely, because the amount of current exciting the slots may vary depending on the distance at which the microstrip line and the slots cross each other, the distances d3, d2, and d1 at which the microstrip line and the slots cross each other may be gradually increased (i.e., d3<d2<d1) in order to make the amount of current exciting the three slot groups uniform.

Also, in order to feed the respective slot groups 223, 222, and 221 with the current having the same phase, the portions of the feeder 240 between the slot groups may have the meander form 243. The phase of the current exciting the respective slot groups can be controlled by using the length of the feeder 240 having the meander form 243. Here, the distance between the end 241 of the feeder 240 and the first slot group 221 is λ/4.

One of the purposes intended to be accomplished by the present invention is allowing the RFID reader antenna to stably recognize an RFID tag regardless of the direction of the RFID tag. Thus, the reader antenna must have the characteristics of circular polarization.

In order to allow the RFID reader antenna to have the characteristics of circular polarization, the respective slots constituting each slot group must physically cross each other, and in this case, if each slot group includes two slots, the phase difference of currents exciting the two slots formed as the slot pair must be 90 degrees. The phase difference of the currents exciting the two slots can be controlled by the distance ‘S’. Namely, the current exciting two slots that cross each other can be adjusted to have the phase difference of 90 degrees by using the distance between the two slots.

Resultantly, the plurality of slot groups may be disposed such that the phase difference between transmission signals by the slot groups is smaller than a predetermined phase difference, and the plurality of slot groups may be configured such that the strength value of the transmission signals by the slot groups may be greater than a predetermined strength value.

For example, the predetermined phase difference may be 5 degrees or 10 degrees based on the transmission signal by the first slot group, and the predetermined strength value may be 5 percent smaller than a maximum strength value.

Also, the strength value of the transmission signal by the slot group may be controlled according to the length of the slot crossing the feeder, and the length of the slot crossing the feeder may be longer as it is closer to the open end of the feeder.

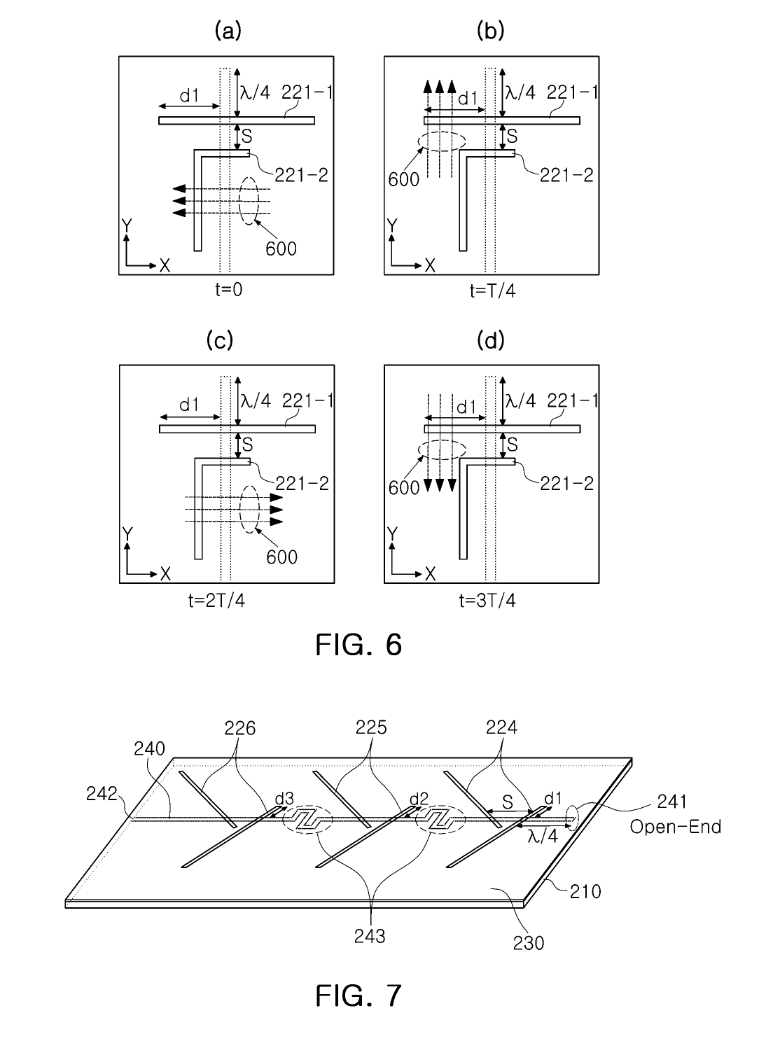

FIG. 6 is a view for explaining the characteristics of circular polarization according to the configuration of the slots of the RFID reader antenna according to an exemplary embodiment of the present invention.

With reference to FIG. 6, it is to be noted that the directions of electric fields formed at the respective slots vary according to the lapse of time. Assuming that two slots constitute a slot group, when the phase difference of currents exciting the two slots is maintained at 90 degrees by appropriately using the distance S between the pair of slots 221-1 and 221-2 constituting the slot group, the electric fields 600 radiated from the pair of slots can have directions such as those shown in FIG. 6.

Namely, the electric field 600 turns a full circle during one period (T) (namely, while time of one period (T) goes by). Namely, if the electric field 600 has a ‘−X’ direction at t=0, the electric field 600 has a ‘Y’ direction at t=T/4, an ‘X’ direction at t=2T/4, and a ‘−Y’ direction at t=3T/4.

FIG. 7 is a perspective view showing the configuration of slots of the RFID reader antenna according to another exemplary embodiment of the present invention.

With reference to FIG. 7, the RFID reader antenna according to an exemplary embodiment of the present invention is configured as a single-layered PCB which is fed in series by the feeder. The RFID reader antenna according to the present exemplary embodiment includes the PCB 210 configured as a single dielectric substance, the feeder 240 formed at a lower end of the PCB 210 and feeding power, and the ground face 230 formed at an upper end of the PCB 210. A plurality of slot groups 224, 225, and 226 for radiating electromagnetic waves may exist on the ground face 230.

When the plurality of slot groups 224, 225, and 226 are fed in series by using the feeder 240, the amount of current is gradually reduced toward the end 241 from the feeding point 242, so the amount of current exciting the pair of slots of the final stage may be very small. Namely, the current, starting to feed from the feeding point 242, excites the first slot group 226, the second slot group 225, and then the last slot group 224, and while performing this process, the exciting current is gradually reduced while passing through the slot groups 226, 225, and 224.

Thus, in the exemplary embodiment of the present invention, in order to solve this problem, the distances d3, d2, and d1 at which the feeder 240 and the slots cross each other are used. Namely, because the amount of current exciting the slots may vary depending on the distance at which the microstrip line and the slots cross each other, the distances d3, d2, and d1 where the microstrip line and the slots cross each other may be gradually increased (i.e., d3<d2<d1) in order to make the amount of current exciting the three slot groups uniform.

Also, in order to feed the respective slot groups 226, 225, and 224 with the current having the same phase, the portions of the feeder 240 between the slots may have the meander form 243.

Also, in order to allow the RFID reader antenna of FIG. 7 to have the characteristics of circular polarization, the respective slots must physically cross each other, and the phase difference of currents exciting the two slots formed as the slot pair must be 90 degrees. The phase difference of the currents exciting the two slots can be controlled by the distance ‘S’. Namely, the current exciting two slots that cross each other can be adjusted to have the phase difference of 90 degrees by using the distance between the two slots.

In addition, if the slot group includes three or more slots, the phase difference of currents at the respective slots may be controlled to have a different value such as a phase difference of 60 degrees or the like.

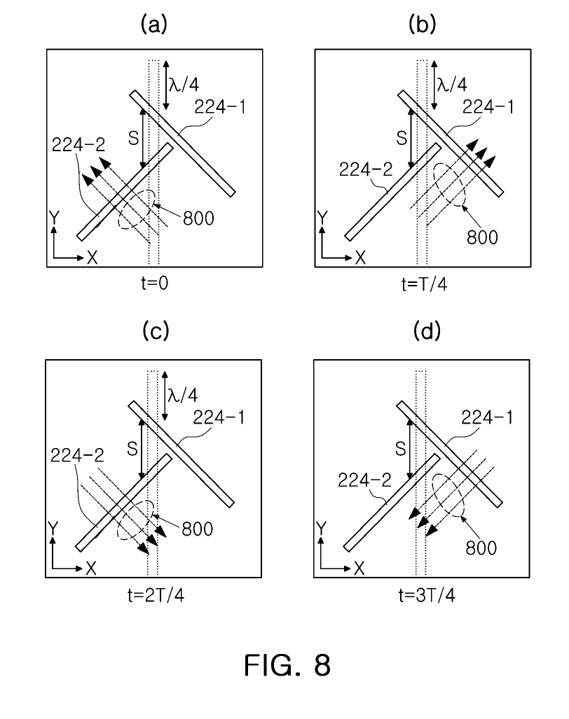

FIG. 8 is a view for explaining the characteristics of circular polarization according to the configuration of the slots of the RFID reader antenna according to another exemplary embodiment of the present invention.

With reference to FIG. 8, it is to be noted that, in the RFID reader antenna according to the present exemplary embodiment, the directions of electric fields formed at the respective slots vary according to the lapse of time. When the phase difference of currents exciting the two slots is maintained at 90 degrees by appropriately using the distance S between the pair of slots 224-1 and 224-2 constituting the slot group 224, the electric fields 800 radiated from the pair of slots can have such directions as shown in FIG. 8. Namely, the electric field 800 turns full circle during one period (T) (namely, while time of one period (T) goes by).

Meanwhile, the RFID reader antenna may use the wavelength of the UHF band and may provide both the near field and the far field.

In addition, an RFID shelf including an RFID reader antenna may include a printed circuit board (PCB) formed as a dielectric substance, a plurality of slot groups, each having a plurality of slots, disposed on a first face of the PCB, a ground face disposed on areas, excluding the plurality of slot groups, of the first face of the PCB, and a feeder formed as a microstrip line with an open end on a second face of the PCB to feed the plurality of slot groups.

In the RFID shelf including an RFID reader antenna, the slot groups may be disposed such that transmission signals by the slot groups exhibit the characteristics of circular polarization, and the characteristics of circular polarization of the transmission signals by the slot groups may depend on the distance between the slots constituting the slot group. Also, the slots constituting the slot groups in the RFID shelf including an RFID reader antenna may be disposed such that the transmission signals by the slots cross each other.

As set forth above, according to the exemplary embodiments of the invention, the single-layered RFID reader antenna and the RFID shelf having the same can use the combined characteristics of a near field and a far field to provide a near field zone of an extensive range in an ILT RFID application.

Namely, because the slots periodically formed on the ground face are fed in series by using the single microstrip line, the RFID reader antenna can reliably recognize a larger area with a simple structure.

In particular, the RFID reader antenna can be useful for the bookstands for book management or smart shelves for displaying articles or goods including clothing goods in superstores or hypermarkets through the use of the ILT RFID application.

While the present invention has been shown and described in connection with the exemplary embodiments, it will be apparent to those skilled in the art that modifications and variations can be made without departing from the spirit and scope of the invention as defined by the appended claims.

What is claimed is:

1. A radio frequency identification (RFID) reader antenna comprising:
a printed circuit board (PCB) formed as a dielectric substance;
a plurality of slot groups, each having a plurality of slots, disposed on a first face of the PCB;
a ground face disposed on areas, excluding the plurality of slot groups, of the first face of the PCB; and
a feeder formed as a microstrip line with an open end on a second face of the PCB to feed the plurality of slot groups.

2. The RFID reader antenna of claim 1, wherein the plurality of slot groups are disposed at a position in which a current distribution value by the feeder is greater than a predetermined current distribution value.

3. The RFID reader antenna of claim 1, wherein the plurality of slot groups are disposed such that a phase difference between transmission signals by the slot groups is smaller than a predetermined phase difference.

4. The RFID reader antenna of claim 1, wherein the plurality of slot groups are configured such that a strength value of the transmission signals by the slot groups is greater than a predetermined strength value.

5. The RFID reader antenna of claim 4, wherein the strength value of the transmission signals by the slot groups is controlled according to the length of a slot crossing the feeder.

6. The RFID reader antenna of claim 5, wherein the slot crossing the feeder is configured such that its length is greater as the slot is closer to the open end of the feeder.

7. The RFID reader antenna of claim 1, wherein the slot groups are disposed such that transmission signals by the slot groups exhibit the characteristics of circular polarization.

8. The RFID reader antenna of claim 7, wherein the characteristics of the circular polarization of the transmission signals by the slot groups are dependent upon the distance between the slots constituting the slot groups.

9. The RFID reader antenna of claim 1, wherein the slots constituting the slot groups are disposed such that the transmission signals by the slots cross each other.

10. The RFID reader antenna of claim 1, wherein the slots constituting the slot groups are disposed such that the phases of the transmission signals by the slots are different.

11. The RFID reader antenna of claim 1, wherein the phases of the transmission signals by the slots constituting the slot groups are controlled according to the distance between the slots.

12. The RFID reader antenna of claim 1, wherein the feeder is disposed such that standing waves are formed.

13. The RFID reader antenna of claim 1, wherein the feeder is formed to provide serial feeding to the respective slot groups.

14. The RFID reader antenna of claim 1, wherein the feeder has the form of meanders in order to compensate for its length.

15. The RFID reader antenna of claim 1, wherein the RFID reader antenna uses an ultra-high frequency (UHF) wavelength.

16. The RFID reader antenna of claim 1, wherein the RFID reader antenna provides both a near field and a far field.

17. A radio frequency identification (RFID) shelf including an RFID reader antenna comprising:
a printed circuit board (PCB) formed as a dielectric substance;
a plurality of slot groups, each having a plurality of slots, disposed on a first face of the PCB;
a ground face disposed on areas, excluding the plurality of slot groups, of the first face of the PCB; and
a feeder formed as a microstrip line with an open end on a second face of the PCB to feed the plurality of slot groups.

18. The RFID shelf of claim 17, wherein the slot groups are disposed such that transmission signals by the slot groups exhibit the characteristics of circular polarization.

19. The RFID shelf of claim 18, wherein the characteristics of the circular polarization of the transmission signals by the slot groups are dependent upon the distance between the slots constituting the slot groups.

20. The RFID shelf of claim 17, wherein the slots constituting the slot groups are disposed such that the transmission signals by the slots cross each other.
